(19) United States
(12) Patent Application Publication
(10) Pub. No.: US 2012/0106472 A1
(43) Pub. Date: May 3, 2012

(54) Methods, Apparatuses, System, Related Computer Program Product and Data Structure for Uplink Scheduling

(75) Inventors: Claudio Rosa, Randers (DK); Frank Frederiksen, Klarup (DK); Esa Tapani Tiirola, Kempele (FI); Kari Pekka Pajukoski, Oulu (FI); Kari Juhani Hooli, Oulu (FI); Sabine Roessel, Munchen (DE); Carsten Ball, Munchen (DE)

(73) Assignee: Nokia Siemens Networks OY, Espoo (FI)

(21) Appl. No.: 13/262,047

(22) PCT Filed: Mar. 31, 2009
(86) PCT No.: PCT/EP2009/053827

§ 371 Date: Nov. 22, 2011

(51) Int. Cl. H04W 72/04; H04W 72/08

(52) U.S. Cl. 370/329

(57) ABSTRACT

It is disclosed a method (and related apparatus) including allocating a first bandwidth portion of a first transmission channel of a first communication network cell based on a restriction imposed by a second bandwidth portion, at least partially overlapping the first bandwidth portion, of a second transmission channel of at least one second communication network cell neighboring the first communication network cell; and a method (and related apparatus) including transmitting signals relating to at least one of control and data in an allocated first bandwidth portion of the first transmission channel of the first communication network cell allocated based on the restriction imposed by the second bandwidth portion, at least partially overlapping the first bandwidth portion, of the second transmission channel of the at least one second communication network cell neighboring the first communication network cell.

### FIELD OF THE INVENTION

Examples of the present invention relate to uplink (UL) scheduling (or resource allocation). More specifically, the examples of the present invention relate to methods, apparatuses, a system, a related computer program product and a data structure for UL scheduling. The examples of the present invention may be applicable to a physical uplink control channel (PUCCH) in combination with the physical uplink shared channel (PUSCH) utilized e.g. in long term evolution (LTE).

### BACKGROUND

Considering high frequency reuse e.g. of LTE, PUCCH coverage may be considered as a limiting factor for the performance of LTE systems. Limited PUCCH coverage may be caused by high frequency reuse (e.g. in LTE, a tight frequency reuse 1 may be assumed). Besides the high frequency reuse, there may be multiple users in each cell sharing the narrowband frequency and time resource of PUCCH. Inter-cell interference experienced on the PUCCH may be partially alleviated by utilizing configuration flexibility to arbitrarily allocate PUCCH resources within an available bandwidth.

FIG. 1 shows a communication system 100 that may comprise a user equipment (UE) 101 and a network 103. In turn, the network 103 may comprise an evolved nodeB (eNB) 102. Transmission of data from the UE 101 to the eNB 102, i.e. in the UL, may utilize the PUSCH 104 in which the PUCCH 105 is assigned to (a) certain resource block(s), denoted by black blocks in FIG. 1.

As shown in FIG. 1, first alternative shown in the upper half of FIG. 1, in order to maintain a single-carrier constraint of single carrier frequency division multiple access (SC-FDMA) impacting user peak data rates, PUCCH 105 resources may be allocated symmetrically (e.g. to provide frequency diversity by means of frequency hopping), starting from the edge of the available UL bandwidth.

In that case, all users in all cells may transmit on the PUCCH 105 using frequency resources e.g. at the edge of the available UL spectrum in e.g. at least two resource blocks (RBs). Some interference averaging may be obtained when e.g. PUCCH 105 resources are unused due to UL control information being transmitted over simultaneously allocated PUSCH 104 resources. Further, not all control channel element (CCE) indices are used for downlink (DL) allocations, thus mapping to a PUCCH 105 resource for acknowledgment/non-acknowledgement (A/N) signaling. However, there may be an interference problem e.g. related to transmission of channel quality indicator (CQI) reports.

Further, as shown in the second alternative shown in the lower half of FIG. 1, non-active PUCCH 105 resource blocks (RBs) may be used for PUSCH 104. For example, assuming that the system bandwidth consists of 50 RBs (e.g. 10 MHz in total), the eNB 102 may reserve e.g. RB #13 and #36 for PUCCH 105 transmission, while still being able to allocate PUSCH 104 resources in the areas from RB#0 to RB#12 and from RB#37 to RB#49.

In consideration of the above, according to examples of the present invention, methods, apparatuses, a system, a related computer program product and a data structure for UL scheduling are provided.

According to an example of the present invention, in a first aspect, this object is for example achieved by a method comprising:

allocating a first bandwidth portion of a first transmission channel of a first communication network cell based on a restriction imposed by a second bandwidth portion, at least partially overlapping the first bandwidth portion, of a second transmission channel of at least one second communication network cell neighboring the first communication network cell.

According to an example of the present invention, in a second aspect, this object is for example achieved by a method comprising:

transmitting signals relating to at least one of control and data in an allocated first bandwidth portion of a first transmission channel of a first communication network cell allocated based on a restriction imposed by a second bandwidth portion, at least partially overlapping the first bandwidth portion, of a second transmission channel of at least one second communication network cell neighboring the first communication network cell.

According to further refinements of the example of the present invention as defined under the above first and second aspects,
an availability of the first bandwidth portion is restricted based on a set of available resource blocks;
the restriction is applicable to predetermined resource blocks of the first bandwidth portion;
the restriction is applicable only to a predetermined part of the first bandwidth portion;
the predetermined part is defined based on a preset parameter indicating a maximum number of resource blocks available for control purposes;
the preset parameter is a N_{RB}^{HO} parameter having the same value for the first and the at least one second communication network cells and being sized based on a scheduling decision relating to the first communication network cell;
the predetermined part is further defined based on a settable parameter in the physical control channel used to signal acknowledgements, negative acknowledgements and scheduling requests;
the predetermined part relates to signaling acknowledgements and negative acknowledgements of a dynamically scheduled downlink shared channel;
the method further comprises a preset parameter N_{PUCCH}⁽¹⁾ for physical uplink control channel configuration;
the method further comprises a preset parameter N_{PUCCH}⁽¹⁾ set such that a border of cell-specific resources is in-between two resource blocks;
an availability of the first bandwidth portion is restricted based on a medium to high interference level caused by users of the at least one second communication network cell;
the interference level of the users is determined based on at least one of a reference signal received power measurement and power headroom reports;
the method further comprises receiving a network parameter defining a pan-network region of the first and second transmission channels;
the network parameter relates to a configuration for configuring each of the first and the at least one second communication network cells to use an individual part of the pan-network region;
the network parameter relates to a configuration for configuring each of the first and the at least one second communication network cells to automatically select the pan-network region from a set of resources defined by the pan-network region;
the automatic selection is based on one of sensing during setup and cell-specific parameter;
the cell-specific parameter is a cell identifier;
the availability of the first bandwidth portion is restricted based on the set of available resource blocks, if a load on the first communication network cell is low to medium, and the availability of the first bandwidth portion is restricted based on the medium to high interference level caused by the users if the load on the first communication network cell is medium to high;
the first and second bandwidth portions are each constituted by at least one resource block;
the resource block relates to a physical uplink control channel;
the resource block relates to a physical uplink shared channel;
the first and second transmission channels are each constituted by a physical uplink shared channel.

According to an example of the present invention, in a third aspect, this object is for example achieved by an apparatus comprising:

means for allocating a first bandwidth portion of a first transmission channel of a first communication network cell based on a restriction imposed by a second bandwidth portion, at least partially overlapping the first bandwidth portion, of a second transmission channel of at least one second communication network cell neighboring the first communication network cell.

According to further refinements of the example of the present invention as defined under the above third aspect,
the apparatus is constituted by an evolved node B.

According to an example of the present invention, in a fourth aspect, this object is for example achieved by an apparatus comprising:

means for transmitting data in an allocated first bandwidth portion of a first transmission channel of a first communication network cell allocated based on a restriction imposed by a second bandwidth portion, at least partially overlapping the first bandwidth portion, of a second transmission channel of at least one second communication network cell neighboring the first communication network cell.

According to further refinements of the example of the present invention as defined under the above fourth aspect,
the apparatus is constituted by a user equipment.

According to further refinements of the example of the present invention as defined under the above third and fourth aspects,
an availability of the first bandwidth portion is restricted based on a set of available resource blocks;
the restriction is applicable to predetermined resource blocks of the first bandwidth portion;
the restriction is applicable only to a predetermined part of the first bandwidth portion;
the predetermined part is defined based on a preset parameter indicating a maximum number of first bandwidth portions reserved for control purposes;
the preset parameter is a N_{RB}^{HO} parameter having the same value for the first and the at least one second communication network cells and being sized based on a scheduling decision relating to the first communication network cell;
the predetermined part is further defined based on a settable parameter in the physical control channel used to signal acknowledgements, negative acknowledgements and scheduling requests;
the predetermined part relates to signaling acknowledgements and negative acknowledgements of a dynamically scheduled downlink shared channel;
the apparatus further comprises a preset parameter N_{PUCCH}⁽¹⁾ for physical uplink control channel configuration;
the apparatus further comprises a preset parameter N_{PUCCH}⁽¹⁾ set such that a border of cell-specific resources is in-between two resource blocks;
an availability of the first bandwidth portion is restricted based on a medium to high interference level caused by users of the at least one second communication network cell;
the interference level of the users is determined based on at least one of a reference signal received power measurement and power headroom reports;
the apparatus further comprises means for receiving a network parameter defining a pan-network region of the first and second transmission channels;
the network parameter relates to a configuration for configuring each of the first and the at least one second communication network cells to use an individual part of the pan-network region;
the network parameter relates to a configuration for configuring each of the first and the at least one second communication network cells to automatically select the pan-network region from a set of resources defined by the pan-network region;
the automatic selection is based on one of sensing during setup and cell-specific parameter;
the cell-specific parameter is a cell identifier;
the availability of the first bandwidth portion is restricted based on the set of available resource blocks, if a load on the first communication network cell is low to medium, and the availability of the first bandwidth portion is restricted based on the medium to high interference level caused by the users if the load on the first communication network cell is medium to high;
the first and second bandwidth portions are each constituted by at least one resource block;
the resource block relates to a physical uplink control channel;
the resource block relates to a physical uplink shared channel;
the first and second transmission channels are each constituted by a physical uplink shared channel;
at least one, or more of means for allocating, means for transmitting and means for receiving and the apparatus is implemented as a chipset or module.

According to an example of the present invention, in a fifth aspect, this object is for example achieved by an apparatus comprising:

an allocator configured to allocate a first bandwidth portion of a first transmission channel of a first communication network cell based on a restriction imposed by a second bandwidth portion, at least partially overlapping the first bandwidth portion, of a second transmission channel of at least one second communication network cell neighboring the first communication network cell.

According to further refinements of the example of the present invention as defined under the above fifth aspect,
the apparatus is constituted by an evolved node B.

According to an example of the present invention, in a sixth aspect, this object is for example achieved by an apparatus comprising:

a transmitter configured to transmit data in an allocated first bandwidth portion of a first transmission channel of a first communication network cell allocated based on a restriction imposed by a second bandwidth portion, at least partially overlapping the first bandwidth portion, of a second transmission channel of at least one second communication network cell neighboring the first communication network cell.

According to further refinements of the example of the present invention as defined under the above sixth aspect,
the apparatus is constituted by a user equipment.

According to further refinements of the example of the present invention as defined under the above fifth and sixth aspects,
an availability of the first bandwidth portion is restricted based on a set of available resource blocks;
the restriction is applicable to predetermined resource blocks of the first bandwidth portion;
the restriction is applicable only to a predetermined part of the first bandwidth portion;
the predetermined part is defined based on a preset parameter indicating a maximum number of first bandwidth portions reserved for control purposes;
the preset parameter is a N_{RB}^{HO} parameter having the same value for the first and the at least one second communication network cells and being sized based on a scheduling decision relating to the first communication network cell;
the predetermined part is further defined based on a settable parameter in the physical control channel used to signal acknowledgements, negative acknowledgements and scheduling requests;
the predetermined part relates to signaling acknowledgements and negative acknowledgements of a dynamically scheduled downlink shared channel;
the apparatus further comprises a preset parameter N_{PUCCH}⁽¹⁾ for physical uplink control channel configuration;
the apparatus further comprises a preset parameter N_{PUCCH}⁽¹⁾ set such that a border of cell-specific resources is in-between two resource blocks;
an availability of the first bandwidth portion is restricted based on a medium to high interference level caused by users of the at least one second communication network cell;
the interference level of the users is determined based on at least one of a reference signal received power measurement and power headroom reports;
the apparatus further comprises a receiver configured to receive a network parameter defining a pan-network region of the first and second transmission channels;
the network parameter relates to a configuration for configuring each of the first and the at least one second communication network cells to use an individual part of the pan-network region;
the network parameter relates to a configuration for configuring each of the first and the at least one second communication network cells to automatically select the pan-network region from a set of resources defined by the pan-network region;
the automatic selection is based on one of sensing during setup and cell-specific parameter;
the cell-specific parameter is a cell identifier;
the availability of the first bandwidth portion is restricted based on the set of available resource blocks, if a load on the first communication network cell is low to medium, and the availability of the first bandwidth portion is restricted based on the medium to high interference level caused by the users if the load on the first communication network cell is medium to high;
the first and second bandwidth portions are each constituted by at least one resource block;
the resource block relates to a physical uplink control channel;
the resource block relates to a physical uplink shared channel;
the first and second transmission channels are each constituted by a physical uplink shared channel;
at least one, or more of an allocator, a transmitter and a receiver and the apparatus is implemented as a chipset or module.

According to an example of the present invention, in a seventh aspect, this object is for example achieved by a system comprising:
an evolved nodeB according to the above third or fifth aspects;
a user equipment according to the above fourth or sixth aspects; and
a further evolved nodeB belonging to the at least one second communication network cell.

According to an example of the present invention, in an eighth aspect, this object is for example achieved by a computer program product or computer program comprising code means or code portions for performing a method according to the above first and second aspects when run on a processing means or module.

According to an example of the present invention, in a ninth aspect, this object is for example achieved by a data structure comprising:
a first bandwidth portion related to a first communication network cell, the first bandwidth portion being restricted based on a restriction imposed by a second bandwidth portion, at least partially overlapping the first bandwidth portion, of another data structure of at least one second communication network cell neighboring the first communication network cell.

According to further refinements of the example of the present invention as defined under the above ninth aspect,
an availability of the first bandwidth portion is restricted based on a set of available resource blocks;
the restriction is applicable to predetermined resource blocks of the first bandwidth portion;
the restriction is applicable only to a predetermined part of the first bandwidth portion;
an availability of the first bandwidth portion is restricted based on a medium to high interference level caused by users of the at least one second communication network cell;
the availability of the first bandwidth portion is restricted based on the set of available resource blocks, if a load on the first communication network cell is low to medium, and the availability of the first bandwidth portion is restricted based on the medium to high interference level caused by the users if the load on the first communication network cell is medium to high;
the first and second bandwidth portions are each constituted by at least one resource block;
the resource block relates to a physical uplink control channel;
the resource block relates to a physical uplink shared channel;
the first and second transmission channels are each constituted by a physical uplink shared channel.

In this connection, the example of the present invention enables one or more of the following:
no degradation of PUCCH performance due to co-channel (and adjacent channel) interference;
improvement/no degradation of the system performance;
limiting/controlling interference experienced by the PUCCH in combination with the PUSCH e.g. in LTE;
Avoiding high inter-cell interference for PUCCH in neighboring cells due to that PUCCH in neighboring cells being mapped to the same frequency resources;
Avoiding of PUCCH coverage impacting on the performance of LTE systems, as the number of interfering UEs per PUCCH/physical resource block (PRB) may be relatively high, rendering the interference conditions on the PUCCH more severe as compared to PUSCH (e.g. only one UE per PRB per interfering cell, assuming no MU-MIMO scheduling in use).
Improving the PUCCH coverage in the case of uplink CoMP (co-operative multipoint) reception

### BRIEF DESCRIPTION OF THE DRAWINGS

The examples of the present invention are described herein below with reference to the accompanying drawings, in which:

FIG. 1 shows principles for UL scheduling;

FIG. 2 shows methods for UL scheduling according to a first example of the present invention, and FIG. 2A shows a signal to interference-plus-noise ratio (SINR) distribution with different number of co-channel UEs related to the first example of the present invention;

FIG. 3 shows methods for UL scheduling according to a second example of the present invention;

FIG. 4 shows methods for UL scheduling according to a third example of the present invention;

FIG. 5 shows apparatuses for UL scheduling according to the first example of the present invention;

FIG. 6 shows apparatuses for UL scheduling according to the second example of the present invention;

FIG. 7 shows apparatuses for UL scheduling according to the third example of the present invention; and

FIG. 8 shows data structures for UL scheduling according to the first to third examples of the present invention.

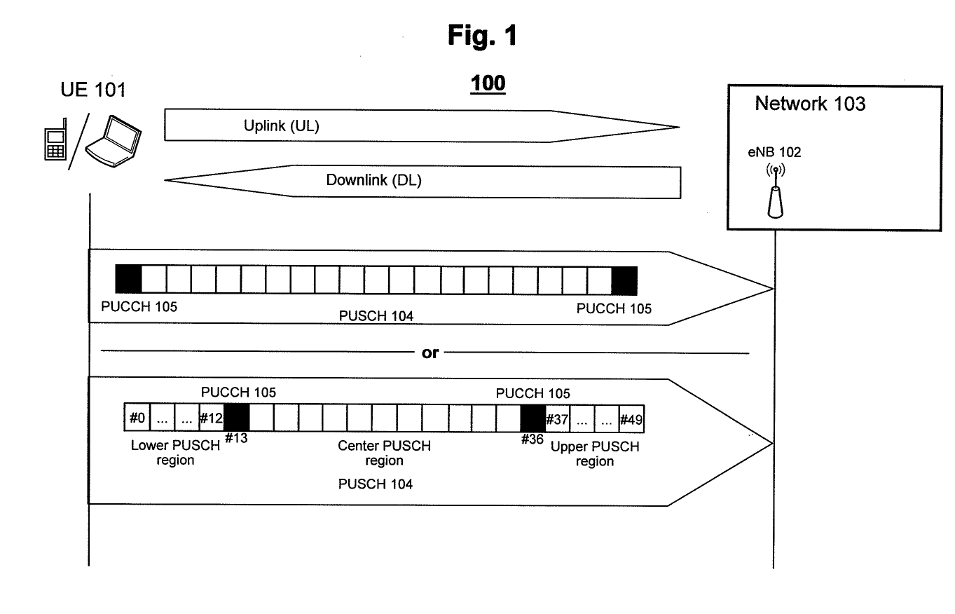

### DETAILED DESCRIPTION OF THE EXAMPLES OF THE PRESENT INVENTION

The examples of the present invention are described herein below by way of example with reference to the accompanying drawings.

It is to be noted that for this description, the terms “RB; RB for PUSCH/PUCCH; and PUSCH” are examples for “first and second bandwidth portions; resource block relating to a physical uplink control channel or resource block relating to a physical uplink shared channel; and first and second transmission channels”, respectively, without restricting the latter-named terms to the special technical or implementation details imposed to the first-named terms.

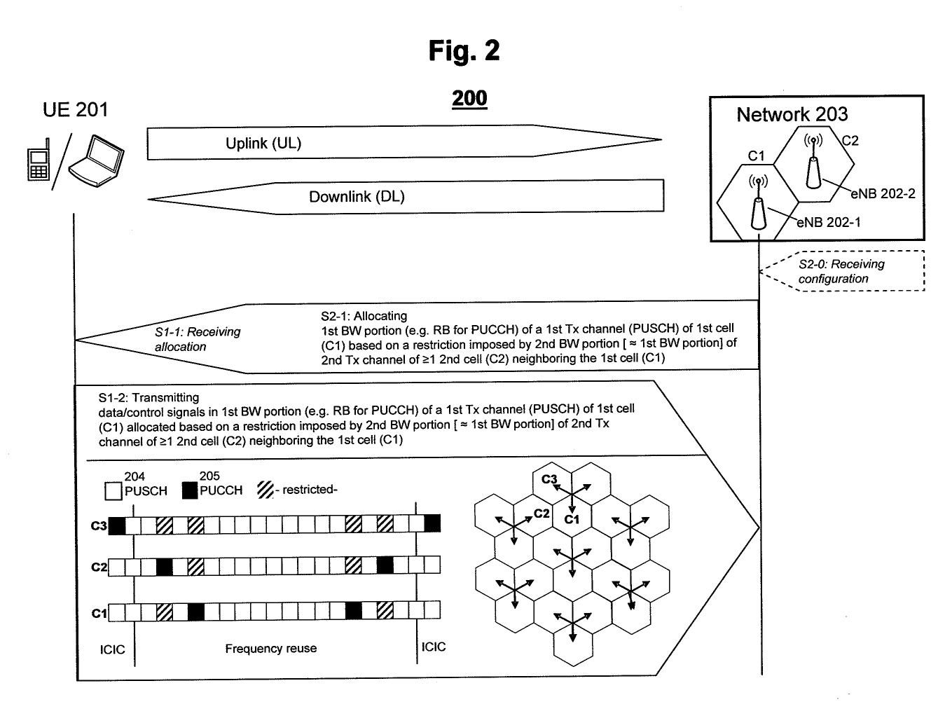

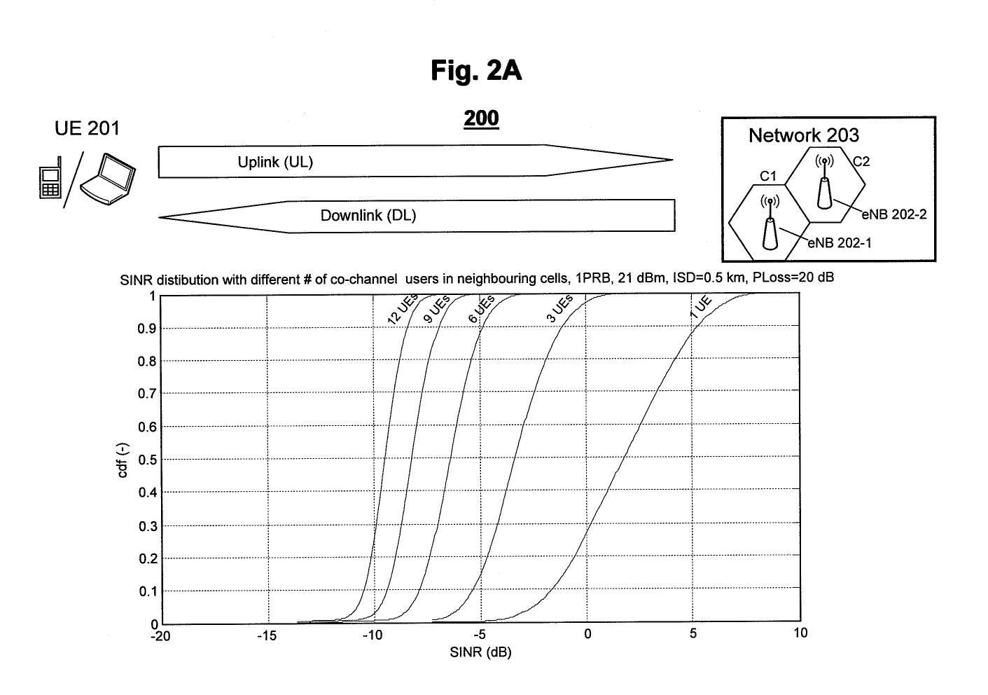

FIGS. 2 to 4 show methods for UL scheduling according to the first to third examples of the present invention. Signaling between elements is indicated in horizontal direction, while time aspects between signaling may be reflected in the vertical arrangement of the signaling sequence as well as in the sequence numbers. It is to be noted that the time aspects indicated in FIGS. 2 to 4 do not necessarily restrict any one of the method steps shown to the step sequence outlined. This applies in particular to method steps that are functionally disjunctive with each other. Within FIGS. 2 to 4, for ease of description, means or portions which may provide main functionalities are depicted with solid functional blocks or arrows and/or a normal font, while means or portions which may provide optional functions are depicted with dashed functional blocks or arrows and/or an italic font.

As shown in FIGS. 2 to 4, a communication system 200 may comprise a UE 201 and a network 203. In turn, the network 202 may comprise a first eNB 202-1 in a first cell C1 and at least on second eNB 202-2 in at least one second cell C2 (or C3, not shown). It is also possible that cell C1 and cell C2 belong to the same eNB (not shown). It may be assumed that the UE 201 is located in cell C1, this not being a limiting choice.

In an optional step S2-0, e.g. the eNB 202-1 (and also the eNB 202-2) may perform receiving a network parameter defining a pan-network region of first and second transmission channels.

Then, in step S2-1, e.g. the eNB 202-1 may perform allocating a first bandwidth portion (e.g. RB for PUCCH 205/PUSCH 204) of the first transmission channel (e.g. PUSCH 204) of a first communication network cell (e.g. C1) based on a restriction imposed by a second bandwidth portion, at least partially overlapping the first bandwidth portion, of the second transmission channel (e.g. PUSCH) of at least one second communication network cell (e.g. C2 or C3) neighboring the first communication network cell. In an optional step S1-1, e.g. the UE 201 may perform receiving the allocation.

In step S1-2, e.g. the UE 201 may perform transmitting signals relating to at least one of control and data in the allocated first bandwidth portion (e.g. RB for PUCCH 205/PUSCH 204) of the first transmission channel (e.g. PUSCH 204) of the first communication network cell (e.g. C1) allocated based on the restriction imposed by the second bandwidth portion, at least partially overlapping the first bandwidth portion, of the second transmission channel of at the least one second communication network cell (e.g. C2 or C3) neighboring the first communication network cell.

As a development, an availability of the first bandwidth portion may be restricted based on a set of available resource blocks.

Further, according to the first example shown in FIGS. 2 and 2A, the restriction may be applicable to predetermined resource blocks of the first bandwidth portion (e.g. so-called fixed frequency reuse). In addition or alternatively, the availability of the first bandwidth portion may restricted based on a medium to high interference level caused by users of the at least one second communication network cell (e.g. so-called ICIC (inter-cell interference coordination)). In the latter case, the interference level of the users may be determined based on at least one of a reference signal received power measurement and power headroom reports.

In case the above fixed frequency reuse and ICIC are used in addition to each other (e.g. so-called load-dependent frequency reuse and ICIC), the availability of the first bandwidth portion may be restricted based on the set of available resource blocks, if a load on the first communication network cell (e.g. C1) is low to medium, and the availability of the first bandwidth portion may be restricted based on the medium to high interference level caused by the users if the load on the first communication network cell (e.g. C1) is medium to high.

As a development of the above latter case (e.g. ICIC), a semi-automatic PUCCH ICIC may be employed. Firstly, there may be an aspect related to centralized control, such that the network parameter received in optional step S2-0 may relate to a configuration for configuring each of the first and the at least one second communication network cells to use an individual part of the pan-network region. Secondly, there may be an aspect related to de-centralized control, such that the network parameter may relate to a configuration for configuring each of the first and the at least one second communication network cells to automatically select the pan-network region from a set of resources defined by the pan-network region. In the latter case (e.g. de-centralized control), the automatic selection may be based on one of sensing during setup and cell-specific parameter. Further, the cell-specific parameter may be a cell identifier.

In relation to the above-defined ICIC, the principle of frequency reuse and ICIC for PUCCH 204 e.g. in LTE uplink is illustrated in the first example shown in FIG. 2. It can be seen that different interference scenarios may take place compared to original deployment, such as interference from PUCCH to PUCCH, PUSCH to PUSCH, PUCCH to PUSCH and PUSCH to PUCCH. In the latter case, interference conditions of PUCCH 205 are improved due to the fact that the number of interfering UEs 201 may be reduced, and FIG. 2A shows an exemplary relationship between the number of co-channel UEs and the cumulative distribution function (cdf) of the SINR.

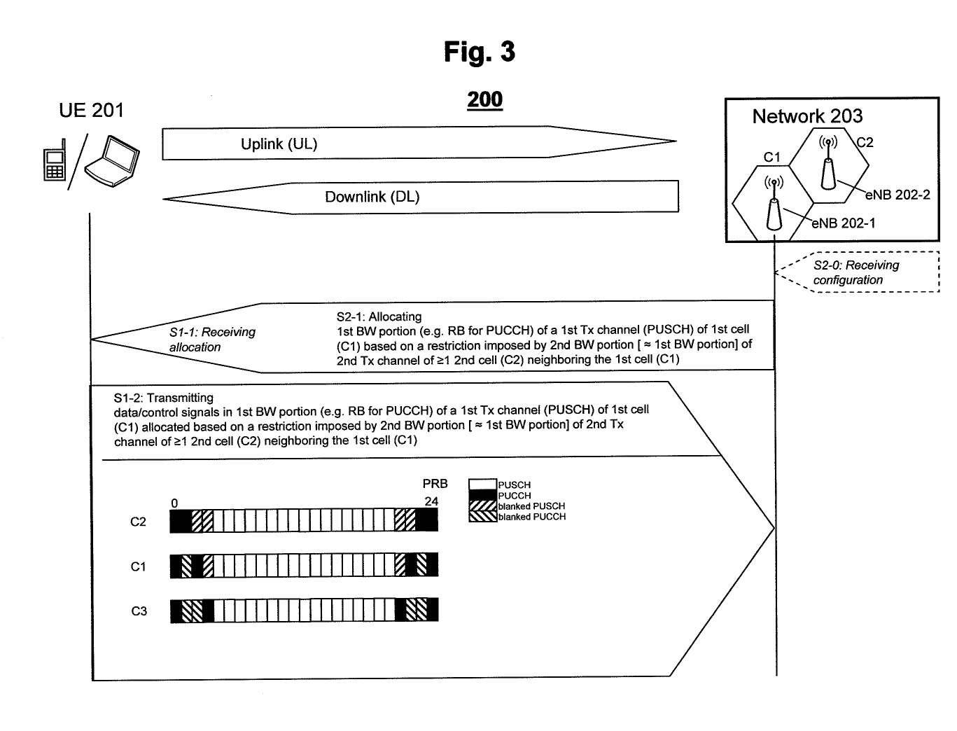

Further, FIG. 3 shows the second example of the present invention relating to a so-called dynamic frequency reuse. In this case, the above-defined restriction may be applicable only to a predetermined part of the first bandwidth portion. Consequently, the predetermined part may be defined based on a preset parameter indicating a maximum number of first bandwidth portions reserved for control purposes, wherein that preset parameter may be a N_{RB}^{HO} parameter having the same value for the first (e.g. C1) and the at least one second (e.g. C2 or C3) communication network cells and being sized based on a scheduling decision relating to the first communication network cell (e.g. C1).

Moreover, it may be possible to employ frequency reuse between cells e.g. only at the physical resource block (PRB) level. This may be based on the fact that different base sequences may be in use in different cells. Furthermore, there may be many randomization schemes in use, based on the cell ID, such as i) symbol-based cyclic shift hopping, ii) slot-based base sequence hopping or iii) PUCCH resource re-mapping between two slots. However, it may be possible to set the N_{RB}^{HO} parameter in different cells such that a logical channel border may be at an RB border.

Still further, the predetermined part may be further defined based on a settable parameter in the physical control channel used to signal acknowledgements, negative acknowledgements and scheduling requests.

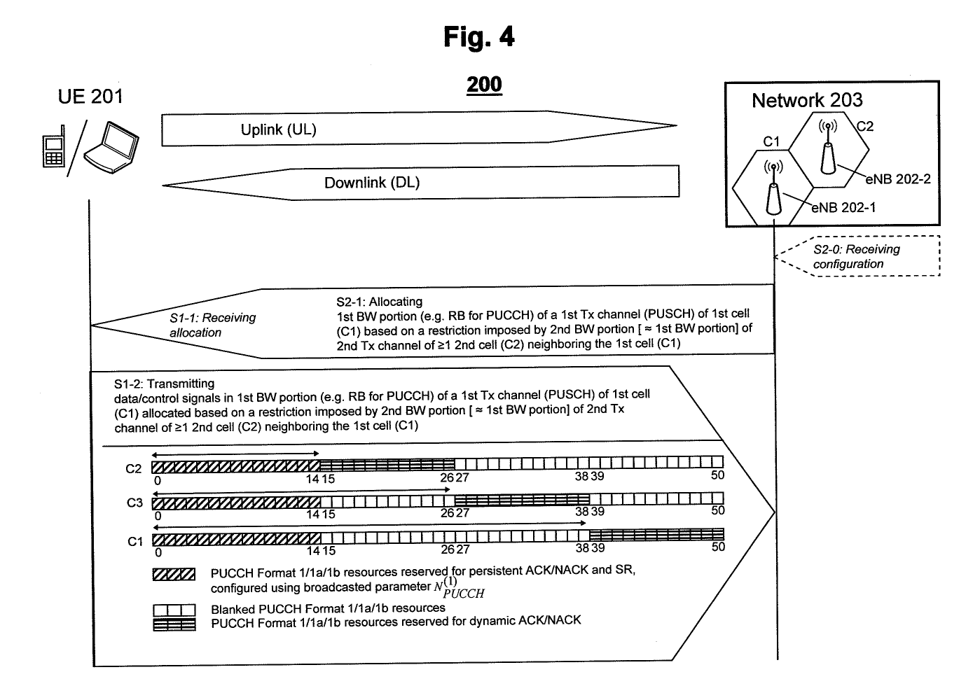

FIG. 4 shows the third example of the present invention also relating to dynamic frequency reuse. In that case, the above-defined predetermined part may relate to signaling acknowledgements and negative acknowledgements of a dynamically scheduled downlink shared channel. Further, there may be a N_{PUCCH}⁽¹⁾ parameter for physical uplink control channel configuration or a N_{PUCCH}⁽¹⁾ parameter set such that a border of cell-specific resources may be in-between two resource blocks.

As developments of the methods according to the first to third examples of the present invention, the first and second bandwidth portions may each be constituted by at least one resource block. Further, the resource block may relate to a physical uplink control channel or a physical uplink shared channel. Finally, the first and second transmission channels may each be constituted by a physical uplink shared channel.

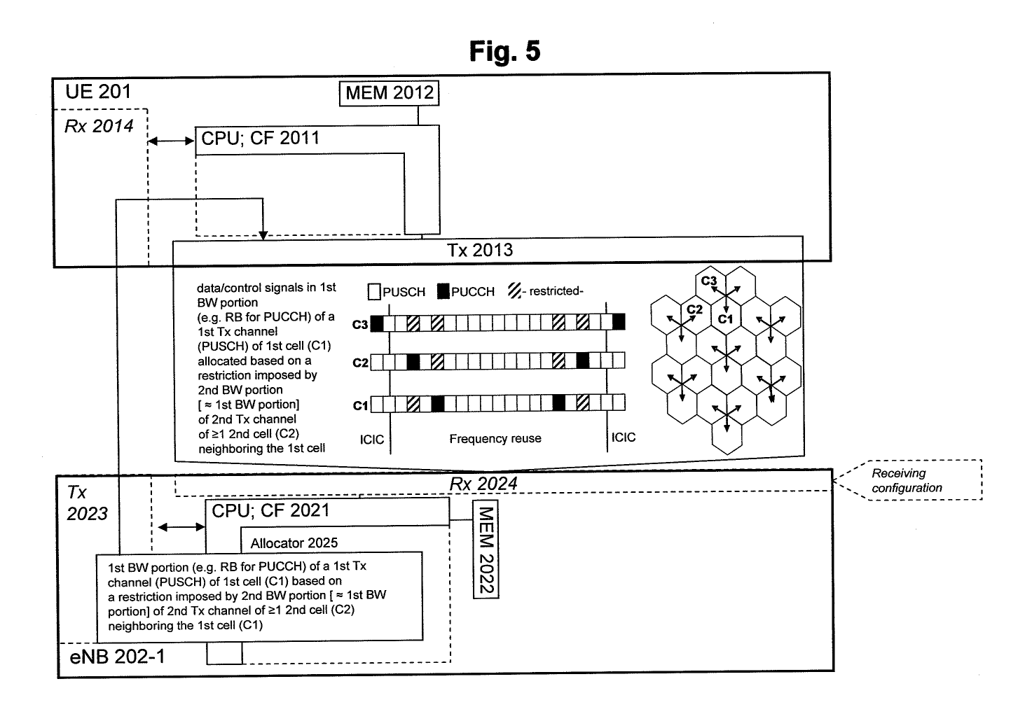

FIGS. 5 to 7 show apparatuses (e.g. UE 201 and eNB 202-1) for UL scheduling according to the first to third examples of the present invention. Within FIGS. 5 to 7, for ease of description, means or portions which may provide main functionalities are depicted with solid functional blocks or arrows and a normal font, while means or portions which may provide optional functions are depicted with dashed functional blocks or arrows and an italic font.

The UE 201 may comprise a CPU (or core functionality CF) 2011, a memory 2012, a transmitter (or means for transmitting) 2013, and an optional receiver (or means for receiving) 2014.

Further, the eNB 202-1 may comprise a CPU (or core functionality CF) 2021, a memory 2022, an optional transmitter (or means for transmitting) 2023, an optional receiver (or means for receiving) 2024 and an allocator (or means for allocating) 2025.

As indicated by the dashed extensions of the functional blocks of the CPUs 2011 and 2021, the means for allocating 2025 of the eNB 202-1 may be a functionality running on the CPUs 2011 and 2021 of the UE 201 or the eNB 202-1, respectively, or may alternatively be a separate functional entity or means.

The CPUs 20x1 (wherein x=1 and 2) may respectively be configured to process various data inputs and to control the functions of the memories 20x2, the means for transmitting 202x3 and the means for receiving 20x4 (and the means for allocating 2025 of the eNB 202-1). The memories 20x2 may serve e.g. for storing code means for carrying out e.g. the methods according to the example of the present invention, when run e.g. on the CPUs 20x1. It is to be noted that the means for transmitting 20x3 and the means for receiving 20x4 may alternatively be provided as respective integral transceivers. It is further to be noted that the transmitters/receivers may be implemented i) as physical transmitters/receivers for transceiving e.g. via the air interface (e.g. between the UE 201 and the eNB 202-1), ii) as routing entities e.g. for transmitting/receiving data packets e.g. in a PS (packet switching) network (e.g. between the eNB 202-1 and another eNB 202-2 when disposed as separate network entities), iii) as functionalities for writing/reading information into/from a given memory area (e.g. in case of shared/common CPUs or memories e.g. of the eNB 202-1 and a network controller when disposed as an integral network entity), or iv) as any suitable combination of i) to iii).

For example, the means for receiving 2024 of the eNB 202-1 may perform receiving a network parameter defining a pan-network region of first and second transmission channels.

Then, e.g. the means for allocating 2025 of the eNB 202-1 may perform allocating a first bandwidth portion (e.g. RB for PUCCH 205/PUSCH 204) of the first transmission channel (e.g. PUSCH 204) of a first communication network cell (e.g. C1) based on a restriction imposed by a second bandwidth portion, at least partially overlapping the first bandwidth portion, of the second transmission channel (e.g. PUSCH) of at least one second communication network cell (e.g. C2 or C3) neighboring the first communication network cell. Optionally, e.g. the means for receiving 2014 of the UE 201 may perform receiving the allocation.

Then, e.g. the means for transmitting 2013 of the UE 201 may perform transmitting signals relating to at least one of control and data in the allocated first bandwidth portion (e.g. RB for PUCCH/PUSCH) of the first transmission channel (e.g. PUSCH) of the first communication network cell (e.g. C1) allocated based on the restriction imposed by the second bandwidth portion, at least partially overlapping the first bandwidth portion, of the second transmission channel of at the least one second communication network cell (e.g. C2 or C3) neighboring the first communication network cell.

As a development, an availability of the first bandwidth portion may be restricted based on a set of available resource blocks.

Further, according to the first example shown in FIG. 5, the restriction may be applicable to predetermined resource blocks of the first bandwidth portion (e.g. so-called fixed frequency reuse). In addition or alternatively, the availability of the first bandwidth portion may restricted based on a medium to high interference level caused by users of the at least one second communication network cell (e.g. so-called ICIC). In the latter case, the interference level of the users may be determined based on at least one of a reference signal received power measurement and power headroom reports.

In case the above fixed frequency reuse and ICIC are used in addition to each other (e.g. so-called load-dependent frequency reuse and ICIC), the availability of the first bandwidth portion may be restricted based on the set of available resource blocks, if a load on the first communication network cell (e.g. C1) is low to medium, and the availability of the first bandwidth portion may be restricted based on the medium to high interference level caused by the users if the load on the first communication network cell (e.g. C1) is medium to high.

As a development of the above latter case (e.g. ICIC), a semi-automatic PUCCH ICIC may be employed. Firstly, there may be an aspect related to centralized control, such that the network parameter received by the means for receiving 2024 of the eNB 202-1 may relate to a configuration for configuring each of the first and the at least one second communication network cells to use an individual part of the pan-network region. Secondly, there may be an aspect related to de-centralized control, such that the network parameter may relate to a configuration for configuring each of the first and the at least one second communication network cells to automatically select the pan-network region from a set of resources defined by the pan-network region. In the latter case (e.g. de-centralized control), the automatic selection may be based on one of sensing during setup and cell-specific parameter. Further, the cell-specific parameter may be a cell identifier.

In relation to the above-defined ICIC, the principle of frequency reuse and ICIC for PUCCH 204 e.g. in LTE uplink is illustrated in the first example shown in FIG. 5. It can be seen that different interference scenarios may take place compared to original deployment, such as interference from PUCCH to PUCCH, PUSCH to PUSCH, PUCCH to PUSCH and PUSCH to PUCCH. In the latter case, interference conditions of PUCCH 205 are improved due to the fact that the number of interfering UEs 201 may be reduced.

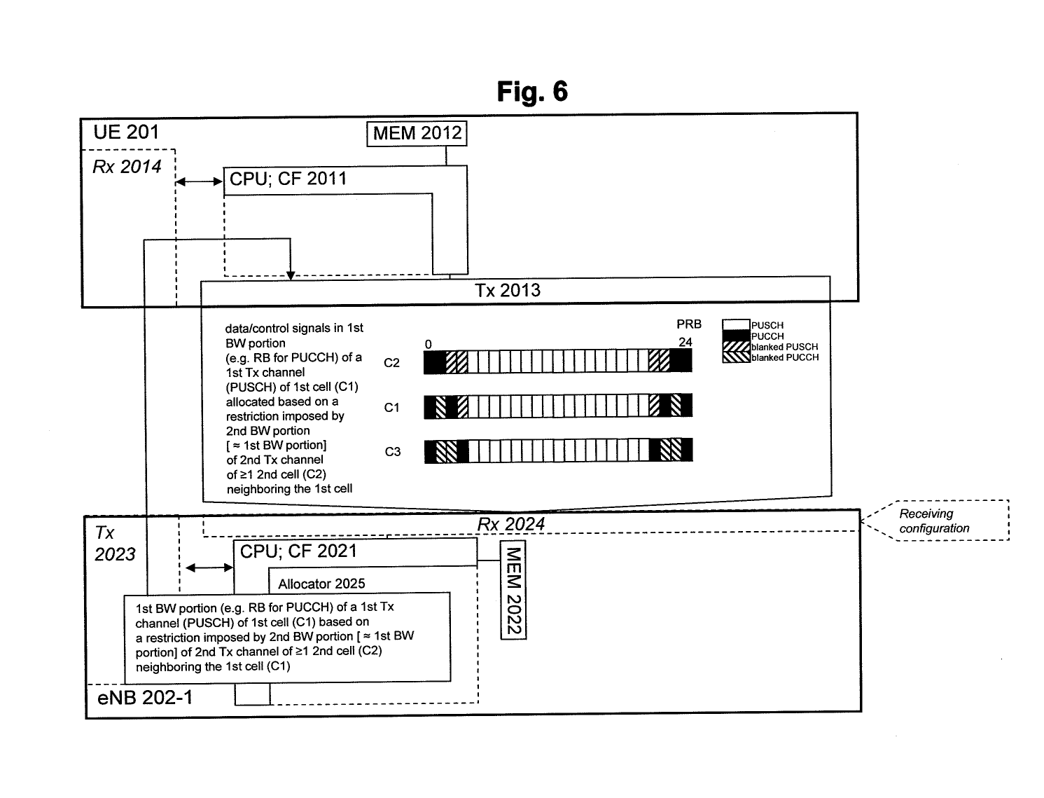

Further, FIG. 6 shows the second example of the present invention relating to a so-called dynamic frequency reuse. In this case, the above-defined restriction may be applicable only to a predetermined part of the first bandwidth portion. Consequently, the predetermined part may be defined based on a preset parameter indicating a maximum number of first bandwidth portions reserved for control purposes, wherein that preset parameter may be a N_{RB}^{HO} parameter having the same value for the first (e.g. C1) and the at least one second (e.g. C2 or C3) communication network cells and being sized based on a scheduling decision relating to the first communication network cell (e.g. C1).

Moreover, it may be possible to employ frequency reuse between cells e.g. only at the physical resource block (PRB) level. This may be based on the fact that different base sequences may be in use in different cells. Furthermore, there may be many randomization schemes in use, based on the cell ID, such as i) symbol-based cyclic shift hopping, ii) slot-based base sequence hopping or iii) PUCCH resource re-mapping between two slots. However, it may be possible to set the N_{RB}^{HO} parameter in different cells such that a logical channel border may be at an RB border.

Still further, the predetermined part may be further defined based on a settable parameter in the physical control channel used to signal acknowledgements, negative acknowledgements and scheduling requests.

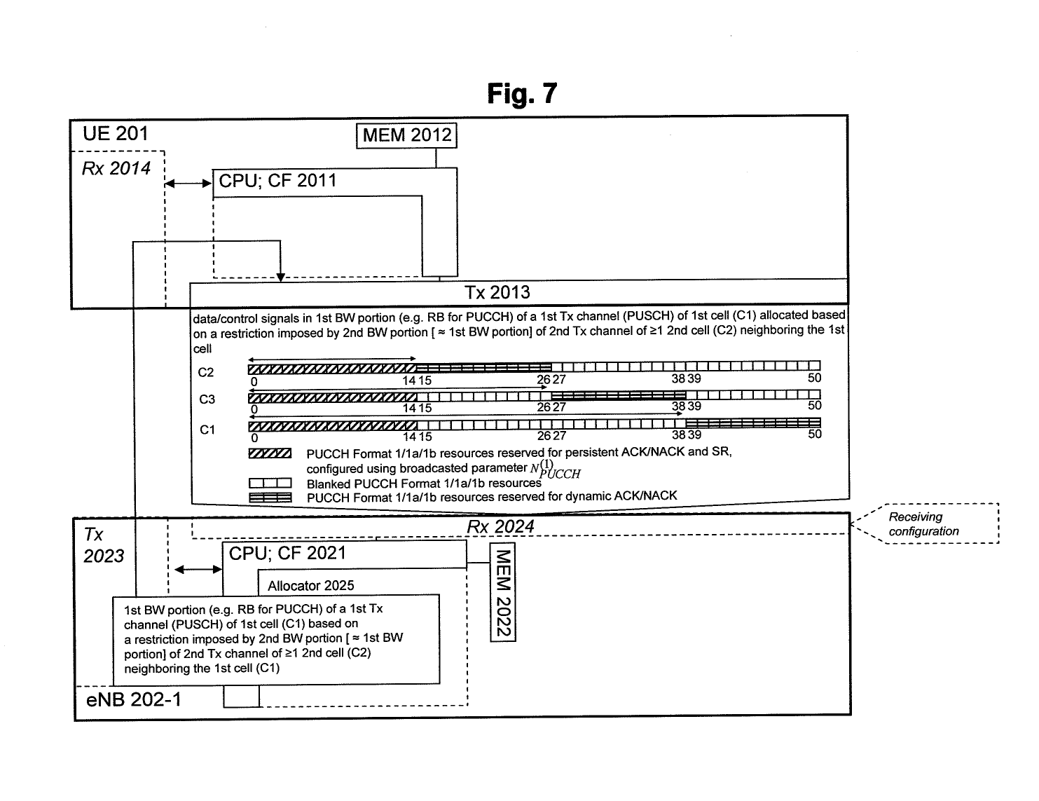

FIG. 7 shows the third example of the present invention also relating to dynamic frequency reuse. In that case, the above-defined predetermined part may relate to signaling acknowledgements and negative acknowledgements of a dynamically scheduled downlink shared channel. Further, there may be a preset parameter may be a N_{PUCCH}⁽¹⁾ parameter for physical uplink control channel configuration or a N_{PUCCH}⁽¹⁾ parameter set such that a border of cell-specific resources may be in-between two resource blocks.

As developments of the apparatuses according to the first to third examples of the present invention, the first and second bandwidth portions may each be constituted by at least one resource block. Further, the resource block may relate to a physical uplink control channel or a physical uplink shared channel. Finally, the first and second transmission channels may each be constituted by a physical uplink shared channel.

Furthermore, at least one of, or more of the above-described means for transmitting 2013, the means for receiving 2024, the means for allocating 2025 as well as the UE 201 and the eNB 202-1, or the respective functionalities carried out, may be implemented as a chipset or module.

Finally, the present invention also relates to a system which may comprise the UE 201 and the eNB 202-1 according to the above-described first to third examples of the present invention as well as at least one further eNB 202-2.

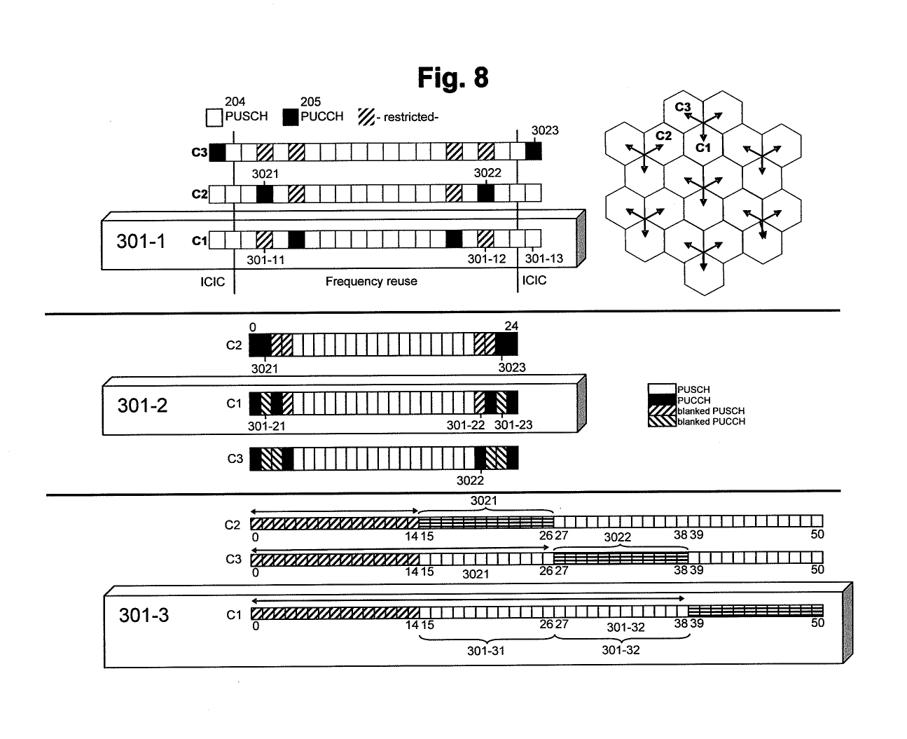

Further, FIG. 8 shows data structures 301-1, 301-2, 301-3 according to the first to third examples of the present invention. The data structures (being e.g. a PUSCH utilized cell C1) may comprise a first bandwidth portion (denoted by blocks 301-11, 301-12, 301-13; 301-21, 301-22, 301-23; and 301-31, 301-32) related to a first communication network cell (e.g. C1), the first bandwidth portion being restricted based on a restriction imposed by a second bandwidth portion (denoted by blocks 3021 to 3023), identical to the first bandwidth portion, of another data structure (e.g. PUSCH of cells C2 and/or C3) of at least one second communication network cell (e.g. C2 and/or C3) neighboring the first communication network cell.

According to the first and second examples of the data structure 301-1, 301-2, an availability of the first bandwidth portion may be restricted based on a set of available resource blocks.

According to the first example of the data structure 301-1 (e.g. for fixed frequency reuse), the restriction may be applicable to predetermined resource blocks of the first bandwidth portion. In addition (e.g. for the above-defined load-dependent frequency reuse and ICIC), the availability of the first bandwidth portion may be restricted based on the set of available resource blocks, if a load on the first communication network cell is low to medium, while the availability of the first bandwidth portion may be restricted based on the medium to high interference level caused by the users if the load on the first communication network cell is medium to high.

According to the second and third examples of the data structure 301-2, 301-3 (e.g. for dynamic frequency reuse), the restriction may be applicable only to a predetermined part of the first bandwidth portion.

As developments of the data structure according to the first to third examples of the present invention, the first and second bandwidth portions may each be constituted by at least one resource block. Moreover, the resource block may relate to a physical uplink control channel or a physical uplink shared channel. Finally, the first and second transmission channels may each be constituted by a physical uplink shared channel.

Without being restricted to the details following in this section, the embodiment of the present invention may be summarized as follows:

It is proposed a way to limit/control the interference experienced on the Physical Uplink Control Channel (PUCCH) in LTE. The main idea may be to allocate PUCCH resources to different parts of the spectrum in neighboring sectors, and then to apply particular scheduling restrictions on those RBs which are used for PUCCH in neighboring sectors in order to provide frequency reuse and/or inter-cell interference control.

PUCCH resources may be allocated to different parts of the spectrum in neighboring cells to ensure that neighboring cells will not have “PUCCH collisions” in the frequency domain. Following this, it may be necessary to apply particular scheduling restrictions on those RBs which are used for PUCCH in neighboring sectors. Furthermore, also the UE specific allocation on PUCCH resources by higher layer RRC signaling during call setup and bearer modification shall take into account the cell specific reuse planning of PUCCH. The main idea may consist in:
Semi-automatic planning of inter-cell PUCCH resource usage coordination based on the global number of required PUCCH resources and exploitation of Cell IDs in the network;
UL transmit power dependent (fractional) frequency reuse;
Combination of fixed and fractional frequency reuse for both the shared (PUSCH) and the control (PUCCH) channels;

In one example, fractional frequency reuse is made only for predetermined PUCCH resources. This principle is shown in FIG. 3. In order to support PUSCH hopping on top of inner PUSCH fragment (i.e., on the frequency denoted as white-colored blocks in FIG. 3), it can be made by setting N_{RB}^{HO}-parameter to be the same in all cells, wherein this broadcasted system parameter can be seen as the maximum number of resource blocks reserved for PUCCH while actual PUCCH size changes dynamically based on PCFICH transmitted on downlink control channel. N_{RB}^{HO} is sized according to PUSCH fragment subject to scheduling decisions (i.e., according to PUSCH of cell C3 in FIG. 3).

Some example applications of the presented invention are reported next:

### Fixed Frequency Reuse:

RBs used for PUCCH in neighbor cells may simply be removed from the set of available RBs for scheduling on PUSCH. The interference conditions on PUCCH may be improved. It is noted that reuse can be applied to the entire PUCCH or only predetermined part of PUCCH, e.g., for dynamic PUCCH.

### ICIC:

RBs used for PUCCH in neighbor cells may allocate to users which are generating a low level of interference to the corresponding eNode-B (possible to obtain this information from RSRP measurement and power headroom reports). The uplink cell throughput is correspondingly increased, as more PRBs are available for UL scheduling.

### Semi-Automatic PUCCH ICIC:

Have a network parameter defining a “global PUCCH” region, which is communicated to all eNBs. In case of centralized control of the eNBs, each eNB is also configured to use its own part of the global PUCCH region, while it is aware of the region which it should target at reducing the interference within. For the configuration of networks with less centralized control of the network deployment, one could allow the eNBs to automatically select the PUCCH region from the set of resources identified by the global PUCCH region. Parameters for this automatic selection could be based on sensing (during setup), and cell-specific parameters (like the Cell ID).

An implementation for the example in which the fractional frequency reuse is made only for dynamic PUCCH part is shown in FIG. 4. It is noted that in certain use cases, it makes sense to limit the fractional reuse only for the dynamic PUCCH since the eNB has full control of the other PUCCH resources, which are semi-static by nature. This can be made by proper parameterization of broadcasted PUCCH configuration parameter N_{PUCCH}⁽¹⁾, which is the number of resources reserved for persistent Format 1/1a/1b resources. FIG. 4 assumes that the other PUCCH-related parameters such as the number of PRBs reserved for PUCCH Format 2 (N_{RB}⁽²⁾) and the number of cyclic shifts reserved for PUCCH Format 1/1a/1b on the mixed PUCCH resource block (N_{CS}⁽¹⁾) as well as the cyclic shift (CS) difference between two adjacent CS resources (Delta_shift) are the same for cell C1, cell C2 and cell C3, this being not a limiting choice.

An advantage provided by the examples of the current invention is the possibility to reduce the inter-cell interference experience on PUCCH. Less interference on PUCCH basically means extended PUCCH coverage.

### FURTHER EXAMPLES

For the purpose of the present invention as described herein above, it should be noted that
an access technology may be any technology by means of which a user equipment can access an access network (or base station, respectively). Any present or future technology, such as WiMAX (Worldwide Interoperability for Microwave Access) or WLAN (Wireless Local Access Network), BlueTooth, Infrared, and the like may be used; although the above technologies are mostly wireless access technologies, e.g. in different radio spectra, access technology in the sense of the present invention may also imply wirebound technologies, e.g. IP based access technologies like cable networks or fixed line.
a network may be any device, unit or means by which a station entity or other user equipment may connect to and/or utilize services offered by the access network; such services include, among others, data and/or (audio-) visual communication, data download etc.;
generally, the present invention may be applicable in those network/user equipment environments relying on a data packet based transmission scheme according to which data are transmitted in data packets and which are, for example, based on the Internet Protocol IP. The present invention is, however, not limited thereto, and any other present or future IP or mobile IP (MIP) version, or, more generally, a protocol following similar principles as (M)IPv4/6, is also applicable;
a user equipment may be any device, unit or means by which a system user may experience services from an access network;
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at the above-defined apparatuses, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may alternatively be based on any security architecture capable e.g. of authentication, authorization, keying and/or traffic protection;
devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

Although the present invention has been described herein before with reference to particular embodiments thereof, the present invention is not limited thereto and various modification can be made thereto.

1. A method, comprising:
allocating a first bandwidth portion of a first transmission channel of a first communication network cell based on a restriction imposed by a second bandwidth portion, at least partially overlapping the first bandwidth portion, of a second transmission channel of at least one second communication network cell neighboring the first communication network cell.

2. A method, comprising:
transmitting signals relating to at least one of control and data in an allocated first bandwidth portion of a first transmission channel of a first communication network cell allocated based on a restriction imposed by a second bandwidth portion, at least partially overlapping the first bandwidth portion, of a second transmission channel of at least one second communication network cell neighboring the first communication network cell.

3. The method according to claim 1, wherein an availability of the first bandwidth portion is restricted based on a set of available resource blocks.

4. The method according to claim 3, wherein the restriction is applicable to predetermined resource blocks of the first bandwidth portion.

5. The method according to claim 3, wherein the restriction is applicable only to a predetermined part of the first bandwidth portion.

6. The method according to claim 5, wherein the predetermined part is defined based on a preset parameter indicating a maximum number of resource blocks available for control purposes.

7. The method according to claim 6, wherein the preset parameter is a N HO/RB parameter having the same value for the first and the at least one second communication network cells and being sized based on a scheduling decision relating to the first communication network cell.

8. The method according to claim 5, wherein the predetermined part is further defined based on a settable parameter in the physical control channel used to signal acknowledgements, negative acknowledgements and scheduling requests.

9. The method according to claim 5, wherein the predetermined part relates to signaling acknowledgements and negative acknowledgements of a dynamically scheduled downlink shared channel.

10. The method according to claim 7, further comprising a preset parameter N (1)/PUCCH for physical uplink control channel configuration.

11. The method according to claim 7, further comprising a preset parameter N (1)/PUCCH set such that a border of cell-specific resources is in-between two resource blocks.

12. The method according to claim 1, wherein an availability of the first bandwidth portion is restricted based on a medium to high interference level caused by users of the at least one second communication network cell.

13. The method according to claim 12, wherein the interference level of the users is determined based on at least one of a reference signal received power measurement and power headroom reports.

14. The method according to claim 1,
wherein an availability of the first bandwidth portion is restricted based on a medium to high interference level caused by users of the at least one second communication network cell, and
further comprising receiving a network parameter defining a pan-network region of the first and second transmission channels.

15. The method according to claim 14, wherein the network parameter relates to a configuration for configuring each of the first and the at least one second communication network cells to use an individual part of the pan-network region.

16. The method according to claim 14, wherein the network parameter relates to a configuration for configuring each of the first and the at least one second communication network cells to automatically select the pan-network region from a set of resources defined by the pan-network region.

17. The method according to claim 16, wherein the automatic selection is based on one of sensing during setup and cell-specific parameter.

18. The method according to claim 17, wherein the cell-specific parameter is a cell identifier.

19. The method according to claim 3, wherein:
an availability of the first bandwidth portion is restricted based on a medium to high interference level caused by users of the at least one second communication network cell, and
wherein the availability of the first bandwidth portion is restricted based on the set of available resource blocks, if a load on the first communication network cell is low to medium, and
the availability of the first bandwidth portion is restricted based on the medium to high interference level caused by the users if the load on the first communication network cell is medium to high.

20. The method according to claim 1, wherein at least one of the following applies:
the first and second bandwidth portions are each constituted by at least one resource block;
the resource block relates to a physical uplink control channel;
the resource block relates to a physical uplink shared channel; and
the first and second transmission channels are each constituted by a physical uplink shared channel.

21. An apparatus, comprising:
means for allocating a first bandwidth portion of a first transmission channel of a first communication network cell based on a restriction imposed by a second bandwidth portion, at least partially overlapping the first bandwidth portion, of a second transmission channel of at least one second communication network cell neighboring the first communication network cell.

22. An apparatus, comprising:
means for transmitting data in an allocated first bandwidth portion of a first transmission channel of a first communication network cell allocated based on a restriction imposed by a second bandwidth portion, at least partially overlapping the first bandwidth portion, of a second transmission channel of at least one second communication network cell neighboring the first communication network cell.

23. The apparatus according to claim 21, wherein an availability of the first bandwidth portion is restricted based on a set of available resource blocks.

24. The apparatus according to claim 23, wherein the restriction is applicable to predetermined resource blocks of the first bandwidth portion.

25. The apparatus according to claim 23, wherein the restriction is applicable only to a predetermined part of the first bandwidth portion.

26. The apparatus according to claim 25, wherein the predetermined part is defined based on a preset parameter indicating a maximum number of first bandwidth portions reserved for control purposes.

27. The apparatus according to claim 26, wherein the preset parameter is a N HO/RB parameter having the same value for the first and the at least one second communication network cells and being sized based on a scheduling decision relating to the first communication network cell.

28. The apparatus according to claim 25, wherein the predetermined part is further defined based on a settable parameter in the physical control channel used to signal acknowledgements, negative acknowledgements and scheduling requests.

29. The apparatus according to claim 25, wherein the predetermined part relates to signaling acknowledgements and negative acknowledgements of a dynamically scheduled downlink shared channel.

30. The apparatus according to claim 27, further comprising a preset parameter N (1)/PUCCH for physical uplink control channel configuration.

31. The apparatus according to claim 27, further comprising a preset parameter N (1)/PUCCH set such that a border of cell-specific resources is in-between two resource blocks.

32. The apparatus according to claim 21, wherein an availability of the first bandwidth portion is restricted based on a medium to high interference level caused by users of the at least one second communication network cell.

33. The apparatus according to claim 32, wherein the interference level of the users is determined based on at least one of a reference signal received power measurement and power headroom reports.

34. The apparatus according to claim 21, further comprising means for receiving a network parameter defining a pan-network region of the first and second transmission channels and,
wherein an availability of the first bandwidth portion is restricted based on a medium to high interference level caused by users of the at least one second communication network cell.

35. The apparatus according to claim 34, wherein the network parameter relates to a configuration for configuring each of the first and the at least one second communication network cells to use an individual part of the pan-network region.

36. The apparatus according to claim 34, wherein the network parameter relates to a configuration for configuring each of the first and the at least one second communication network cells to automatically select the pan-network region from a set of resources defined by the pan-network region.

37. The apparatus according to claim 36, wherein the automatic selection is based on one of sensing during setup and cell-specific parameter.

38. The apparatus according to claim 37, wherein the cell-specific parameter is a cell identifier.

39. The apparatus according to claim 23, wherein:
an availability of the first bandwidth portion is restricted based on a medium to high interference level caused by users of the at least one second communication network cell, and
wherein the availability of the first bandwidth portion is restricted based on the set of available resource blocks, if a load on the first communication network cell is low to medium, and the availability of the first bandwidth portion is restricted based on the medium to high interference level caused by the users if the load on the first communication network cell is medium to high.

40. The apparatus according to claim 21, wherein at least one of the following applies:
the first and second bandwidth portions are each constituted by at least one resource block;
the resource block relates to a physical uplink control channel;
the resource block relates to a physical uplink shared channel; and
the first and second transmission channels are each constituted by a physical uplink shared channel.

41. The apparatus according to claim 21, wherein the apparatus is constituted by an evolved node B.

42. The apparatus according to claim 22, wherein the apparatus is constituted by a user equipment.

43. The apparatus according to claim 21, wherein at least one, or more of means for allocating, means for transmitting and means for receiving and the apparatus is implemented as a chipset or module.

44. A system, comprising: an evolved nodeB according to claim 21; a user equipment comprising means for transmitting data in an allocated first bandwidth portion of a first transmission channel of a first communication network cell allocated based on a restriction imposed by a second bandwidth portion, at least partially overlapping the first bandwidth portion, of a second transmission channel of at least one second communication network cell neighboring the first communication network cell, and a further evolved nodeB belonging to the at least one second communication network cell.

45. A computer program product comprising code means for performing a method according to claim 1 when run on a processing means or module.

46. A data structure, comprising:
a first bandwidth portion related to a first communication network cell, the first bandwidth portion being restricted based on a restriction imposed by a second bandwidth portion, at least partially overlapping the first bandwidth portion, of another data structure of at least one second communication network cell neighboring the first communication network cell.

47. The data structure according to claim 46, wherein an availability of the first bandwidth portion is restricted based on a set of available resource blocks.

48. The data structure according to claim 47, wherein the restriction is applicable to predetermined resource blocks of the first bandwidth portion.

49. The data structure according to claim 47, wherein the restriction is applicable only to a predetermined part of the first bandwidth portion.

50. The data structure according to claim 46, wherein an availability of the first bandwidth portion is restricted based on a medium to high interference level caused by users of the at least one second communication network cell.

51. The data structure according to claim 47, wherein:
an availability of the first bandwidth portion is restricted based on a medium to high interference level caused by users of the at least one second communication network cell, and
wherein the availability of the first bandwidth portion is restricted based on the set of available resource blocks, if a load on the first communication network cell is low to medium, and
the availability of the first bandwidth portion is restricted based on the medium to high interference level caused by the users if the load on the first communication network cell is medium to high.

52. The data structure according to claim 46, wherein at least one of the following applies:
the first and second bandwidth portions are each constituted by at least one resource block;
the resource block relates to a physical uplink control channel;
the resource block relates to a physical uplink shared channel; and
the first and second transmission channels are each constituted by a physical uplink shared channel.
